(19) United States
(12) Patent Application Publication
(10) Pub. No.: US 2013/0036196 A1
(43) Pub. Date: Feb. 7, 2013

(54) METHOD AND SYSTEM FOR PUBLISHING TEMPLATE-BASED CONTENT

(71) Applicants: Boris Kai-Tik Chan, Toronto (CA); Sundeep Singh Madra, Palo Alto, CA (US); Jonathan Mikhail, Toronto (CA); David Protasowski, Oshawa (CA); Sina Sojoodi, Toronto (CA)

(72) Inventors: Boris Kai-Tik Chan, Toronto (CA); Sundeep Singh Madra, Palo Alto, CA (US); Jonathan Mikhail, Toronto (CA); David Protasowski, Oshawa (CA); Sina Sojoodi, Toronto (CA)

(73) Assignee: XTREME LABS INC., Toronto (CA)

(21) Appl. No.: 13/565,331

(22) Filed: Aug. 2, 2012

Related U.S. Application Data
(60) Provisional application No. 61/515,471, filed on Aug. 5, 2011.

(51) Int. Cl. G06F 15/16

(52) U.S. Cl. 709/217

(57) ABSTRACT

A method is provided for publishing content on a mobile device. In response to a request for content from the mobile device, information is retrieved from an application on the device setting out the device's capabilities and native feature set. This device information is then matched to an applicable template via a platform lookup matrix. The matched template is sent to the device for rendering with content, the template including a combination of components reliant on the device's native feature set and generic components from a standard. A programmed mobile device for receiving and rendering published content is also provided.

### CROSS REFERENCE TO RELATED APPLICATION

This application claims priority from U.S. Provisional Application No. 61/515,471 filed on Aug. 5, 2011, which is incorporated by reference in its entirety herein.

### TECHNICAL FIELD

The invention relates to publishing content on mobile devices, and more particularly relates to methods and systems for publishing template-based content.

### BACKGROUND

In the competitive mobile marketplace, a number of mature platforms, for example, iPhone, Blackberry or Android devices backed by industry leaders, vie for consumer attention. But while this variety offers end-users a vast choice in possible mobile devices and operating systems, publishers and other content producers must cope with difficult compatibility issues. Web publishers, for example, cannot simply create a webpage using basic web standards; different devices on different platforms will each support features in an inconsistent fashion, leading to an inconsistent user experience. Further discrepancies can arise from significant differences in basic orientation and screen sizes across devices, in which content is rearranged in a manner which may not be optimal.

To combat this problem, most publishers and other content producers will simply create dedicated versions of their content for major platform groups. For example, most web sites will offer a desktop and a mobile version of their website, while some will further offer versions that cater to one particular mobile platform, such as Apple's iOS. However, this approach, which involves development of a native application for each device or platform is not only time-consuming to implement, but can be difficult to maintain, often requiring additional work and tweaking as new content is generated. The alternative is to develop only one basic generic application that will work across platforms. These generic applications are frequently perceived to be either “buggy” because they do not in fact work completely across every platform and device, or ugly and feature-poor, having limited or no interactivity.

Native applications are more capable than generic applications, but are expensive and slow to roll out because a developer needs to create a separate application for each platform. Generic standards like HTML5 allow a developer to create one application and deploy it to multiple platforms. But standards like HTML5 have functional limitations. Specifically, HTML5 does not permit developers to tap into smartphones' and tablets' native hardware capabilities. This divergence has led to a two-caste system: “real” native apps that fully exploit the hardware and OS, and Web apps that are typically presentation widgets with limited features. Since generic applications cannot make use of the native device hardware directly, they tend to be less appealing because they conform to the lowest common feature-set that is supported across multiple platforms. It would be desirable to provide a method and system for publishing content that combines the strengths of both approaches and avoids some of the foregoing limitations.

### SUMMARY

This invention describes a method for mobile devices in which (a) the user interface of an application can be a mix of native elements and another standard, (b) the application can reside partially or wholly in any proportion on the device and/or a central server. The user interface has platform dependent templates. Transformation occurs upon detecting the platform under which the device is running to optimize the interface and content delivery for the platform.

According to a first aspect of the invention, a method is provided for publishing content on a mobile device. In response to a request for content from the mobile device, information is retrieved from an application on the device setting out the device's capabilities and native feature set. This device information is then matched to an applicable template via a platform lookup matrix. The matched template is sent to the device for rendering with content, the template including a combination of components reliant on the device's native feature set and generic components from a standard.

The content may be sent with the template or separately. The template may be populated with content prior to sending to the device. Alternatively, content may be sent separately from the template to be rendered using the template on the device. In the further alternative, the template may contain instructions for locating and rendering content (e.g. photos, videos, maps, location data, cached web pages) already on the device.

Onboard content and devices can be leveraged. For example, the template may contain instructions for retrieving and rendering on the device content from an onboard GPS, or an onboard camera.

In one embodiment, the template contains instructions for retrieving and rendering on the device content updated at periodic intervals from a web server. The template may include instructions to retrieve or update web content at periodic intervals (whether rendered immediately or stored for later rendering). The template may include native objects that are embedded in a generic framework (or vice versa). A generic component may be supplied in the template if there is no native feature to support that component. Further, a template of reduced graphics or interactivity may be supplied if it is determined from the application that the device has limited memory or processing capacity. The template may contain instructions for rendering a combination of fixed and interactive content.

The template for a given device may be matched/determined in various ways. In one embodiment, the device information includes a fixed specification that is looked up in the platform lookup matrix using a user agent string specific to the device. Alternatively, the device information may include a list of device capabilities that is matched to an applicable template in the platform lookup matrix. Examples of such capabilities include memory capacity, processing speed and capacity, support for file types, screen size and layout, input and output types, and presence of onboard devices (e.g. GPS receiver, camera, compass, gyroscope, and accelerometer), and other capabilities, such as those listed at http://wurfl.sourceforge.net/.

Preferably, the standard is a markup language (e.g. HTML5). Preferably, the template is a cross-platform template matchable to multiple devices having similar capabilities.

According to a second aspect of the invention, a programmed mobile device is provided for receiving and rendering published content. The device is programmed to send a request for content to a central server, together with information retrieved from an application on the device as to the device's capabilities and native feature set. After a template is received that has been matched to the device information via a platform lookup matrix on the central server, the device is programmed to receive and render content via the template. The template includes a combination of components reliant on the device's native feature set and generic components from a standard.

### BRIEF DESCRIPTION OF THE DRAWINGS

FIG. 1 is a sample screen shot of an example of hybrid content published using a template of the present invention.

FIG. 2 is a block diagram of the transaction process where a template is selected depending on the platform.

FIG. 3 is a flowchart diagram of the process used by a mobile device to download templates and render content.

### DETAILED DESCRIPTION

The present invention defines a process and system which allows for the creation of intelligent, modular templates, capable of platform aware capability transformations on computing devices, more specifically mobile devices.

Before embodiments of the software modules or flow charts are described in detail, it should be noted that the invention is not limited to any particular software language described or implied in the figures and that a variety of alternative software languages may be used for implementation of the invention.

It should also be understood that many components and items are illustrated and described as if they were hardware elements, as is common practice within the art. However, one of ordinary skill in the art, and based on a reading of this detailed description, would understand that, in at least one embodiment, the components comprised in the method and tool are actually implemented in software.

As will be appreciated by one skilled in the art, the present invention may be embodied as a system, method or computer program product. Accordingly, the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present invention may take the form of a computer program product embodied in any tangible medium of expression having computer usable program code embodied in the medium.

Computer program code for carrying out operations of the present invention may be written in any combination of one or more programming languages, including an object oriented programming language such as Java, Smalltalk, C++ or the like and conventional procedural programming languages, such as the “C” programming language or similar programming languages. Computer code may also be written in dynamic programming languages that describe a class of high-level programming languages that execute at runtime many common behaviors that other programming languages might perform during compilation. JavaScript, PHP, Perl, Python and Ruby are examples of dynamic languages. Additionally computer code may also be written using a web programming stack of software, which may mainly be comprised of open source software, usually containing an operating system, Web server, database server, and programming language. LAMP (Linux, Apache, MySQL and PHP) is an example of a well-known open-source Web development platform. Other examples of environments and frameworks in which computer code may also be generated are Ruby on Rails which is based on the Ruby programming language, or node.js which is an event-driven server-side JavaScript environment.

The program code may execute entirely on the client device, partly on the client device, as a stand-alone software package, partly on the client device and partly on a remote computer or entirely on the remote computer or server. In the latter scenario, the remote computer may be connected to the client device through any type of network, including a local area network (LAN) or a wide area network (WAN), or the connection may be made to an external computer (for example, through the Internet using an Internet Service Provider).

It will be understood that the device enables a user to engage with an application using the invention, and includes a memory for storing a control program and data, and a processor (CPU) for executing the control program and for managing the data, which includes user data resident in the memory and includes buffered content. The device may be coupled to an external video display such as a television, monitor, or other type of visual display, in addition to or as an alternative to an onboard display. Storage media may be onboard or external, such as a DVD, a CD, flash memory, USB memory or other type of memory media or it may be downloaded from the internet. The storage media can be inserted to the device where it is read. The device can then read program instructions stored on the storage media and present a user interface to the user.

In preferred embodiments, the device is fully mobile and portable (e.g. a laptop, a notebook, a cellular phone, a smartphone, a PDA, an iPhone, an iPad, an iPod, an e-book reader e.g. Kindle or Kindle DX, Nook, etc.), although it will be appreciated that the method could be applied to more fixed (non-portable) computers and related devices with appropriate modifications (e.g. a personal computer (PC), corporate PC, a server, a PVR, a set-top box, wireless enabled Blu-ray player, a TV, a SmartTV, wireless enabled Internet radio) and other such devices that may be used for the viewing and consumption of content whether the content is local, is generated on demand, is downloaded from a remote server where is exists already or is generated as a result.

In some embodiments, the device has a touch-sensitive display with a graphical user interface (GUI), one or more processors, memory and one or more modules, programs or sets of instructions stored in the memory for performing multiple functions. In some embodiments, the user interacts with the GUI primarily through finger contacts and gestures on the touch-sensitive display. Alternatively, or in addition, one or more buttons, keys, keypads, keyboards, track devices, microphones, etc., and other input mechanisms may be provided.

In some embodiments, the in-built functions may include providing maps and directions, telephoning, video conferencing, e-mailing, instant messaging, blogging, digital photography, digital videoing, web browsing, digital music playing, and/or digital video playing. Instructions for performing these functions may be included in a computer readable storage medium or other computer program product configured for execution by one or more processors.

It should be understood that although the term “application” has been used as an example in this disclosure, in essence the term may also apply to any other piece of software code where the embodiments of the invention are incorporated. The software application can be implemented in a standalone configuration or in combination with other software programs and is not limited to any particular operating system or programming paradigm described here. Thus, this invention intends to cover all applications and user interactions described above as well as those obvious to the ones skilled in the art.

Several exemplary embodiments/implementations of the invention have been included in this disclosure. There may be other methods obvious to persons skilled in the art, and the intent is to cover all such scenarios. The application is not limited to the cited examples, but the intent is to cover all such areas that may be benefit from this invention.

The source device (or server) where content is located or generated and recipient device (or client) where content is consumed may be running any number of different operating systems as diverse as Microsoft Windows family, MacOS, iOS, any variation of Google Android, any variation of Linux or Unix, PalmOS, Symbian OS, Ubuntu or such operating systems used for such devices available in the market today or the ones that will become available as a result of the advancements made in such industries.

Turning now to the present method, a small footprint application is preferably first installed on (or accessed from) the mobile device. The user interacts with this application. The application utilizes a data connection with a central server. This application is “hybrid” for several reasons: (a) Rendered UI (user interface) can be the device native and/or a standard such HTML5. (b) Processing can occur on the device and/or server. Data can be on the device and/or on server. Thus the application can reside on the server and/or the device. (c) The application is designed using templates that are platform specific but designs can be shared between platforms.

The application communicates with a central server where data exchanged includes instructions for rendering the user interface (UI) on the device using a template, depending on the platform. For example, instructions may, in one embodiment, through the template, selectively tell which component of the UI should be native, and which should be HTML5 (or another standard) in the same application. Certain native features, such as a picture browser, can be embedded within an HTML5 framework. As well, the application may contain platform native behavior such as pop up controls. These selective instructions are provided by the template.

This hybrid model, a paradigm that combines features of installed and online applications, confers several advantages: (a) the application templates can be more automatically updated since processing can occur server-side and instructions for the UI can be passed down to the device. This saves users from having to download and install new versions from the provider, for example commonly known as an “app store”. For developers, it permits a continuous, rolling deployment.

Using runtime deployment, an application is delivered which executes outside of a development environment. The application cannot be changed or modified without installing an upgrade to the runtime application environment. (The runtime model is particularly appropriate when the application does not enable the creation or modification of database components (for example files, dictionaries, indexes) or application components (for example reports, forms, programs, etc.).

In the mobile app environment, the publishing of the application is a time consuming process. Both in iTunes App Store and Google Marketplace there is an app submission and approval process. Thus if there are changes to the binary of an application, it must be resubmitted for an approval.

Thus to make changes quickly, using runtime deployment in an application is a competitive advantage, since it reduces the time to market, allows for a unified user base, and avoids the need to continuously update the binaries of the application.

For example, in the present case, security updates can be propagated quickly across the board using runtime deployment.

Templates confer the ability to share designs between versions for different platforms; (b) computationally demanding data processing can utilize the power of an online computer system with increased capabilities; (c) frequent, mundane data processing can be delegated to devices that run the hybrid application; and the (d) user interface can be optimized to exploit unique features of the device or compensate for deficiencies where possible.

During the initial install, a default user interface is provided after which updates can occur upon connecting to the central server. While the network connection is unavailable, data—including but not limited to downloaded templates for processing or UI rendering—may in one embodiment of the invention be cached so as to permit continued offline application operation.

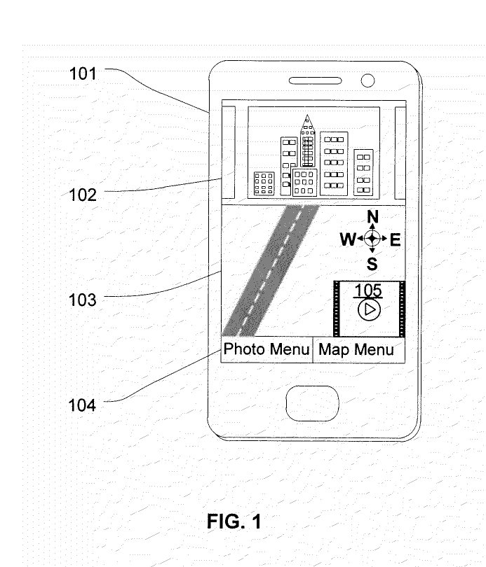

FIG. 1 is an embodiment with a sample application running a hybrid application. The example is a photo viewer (see upper pane). In the lower pane, a map where the photo was taken is displayed together with a video from the location.

Referring to FIG. 1, an application is running in a mobile device 101. The application is comprised of two panes, one containing a photo viewer 102, the other containing a map 103. The photo viewer 102 is a UI element native to the platform. The map and embedded video 105 are in an embedded browser containing HTML5 data. Additionally, action menu buttons 104 (here, Photo Menu and Map Menu) provide functionality using platform native controls.

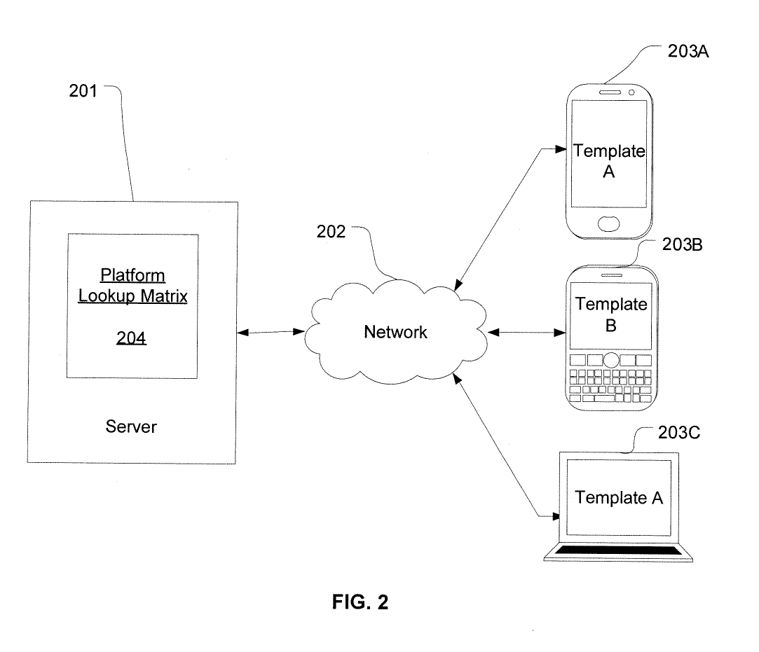

FIG. 2 is a block diagram of the transaction process where a template is selected depending on the platform. Content is published based on the server being aware of the platform.

Referring to FIG. 2, during normal operations, a template exists for one or more pages of the application or for one or more of the functions or content calls that may be requested by the mobile device.

A template is a set of instructions and may be populated by content which can be rendered on web pages. These instructions may be implemented differently on different devices depending on the capabilities of the device and the native instruction sets and standards which the device supports or can implement. A template is a blueprint for creating a new entity. A template captures a frequently used pattern, facilitating uniformity and best practice enforcement across entities created using the template. For example, a template may allow a user to quickly generate a new document, file, data structure, web page, and so on, without having to rebuild commonly used elements from scratch. In another example, best practice solution patterns designed by an expert may be captured in templates and reused in projects, aiding in best practice enforcement, and making the expert's knowledge available to multiple projects in the expert's domain of specialization.

In one embodiment of the present invention, the templates are composed of a combination of native elements and HTML5 elements. To illustrate a simple use of templates across platforms, consider an illustrative template for displaying a list of photos with their captions. By querying the device, an appropriate template can be provided that “knows” and can take advantage of the device's unique capabilities (or the capabilities/limitations of the particular device and/or platform type or version).

On a high-end capable device, the template would be translated so that the resulting output is a native list with each cell containing a photograph and caption. Because the phone is highly capable, the output from the template includes additional niceties such as an extra animation when the user scrolls when the cell comes into focus.

On a mid-range device that does not support animations, the invention uses a template that displays an HTML5 page with a basic list of photographs.

Finally, on a low-end device, due to memory limitations the invention would use a template that instead of displaying a list of photographs and captions, just shows captions whereby a user can click on an individual caption and then view the associated image. Thus, we see that depending on the device, the template will be different.

In the present case, as seen in FIG. 2, the templates may be stored in server 201. Also stored in server 201 is a matrix 204 that relates the name or identity of the supported device platforms to one or more pages or functions or content calls in the application to an appropriate template.

In one possible embodiment, the platform lookup matrix may take the form of a database of user agents that map to devices with these attributes: browser version/features (for example, has hardware acceleration, supports CSS3: use native animations instead of javascript ones), hardware capabilities (has camera, accelerometer, gyroscope compass etc.), platform version (iOS, Android: when rendering a web element, the invention can make it look like it is native to the platform)

To facilitate this lookup and matching, one might use a combination of a pre-existing database (such as WURFL: http://wurfl.sourceforge.net/), together with libraries to detect features on the phone, and features on browser versions.

Some elements in the matrix may be common. When the server 201 receives a request from any given supported mobile device 203, the server first determines whether the function or call requires intermediation via a template. This is done because some simple calls and functions may not require the template intermediation, for example, a location request would return its simple JSON with latitude and longitude information without any need to go through a template

JSON (JavaScript Object Notation) is a lightweight data-interchange format that is a current common standard for serialized data in mobile since it is less bandwidth-intensive than XML. JSON is built on two structures: (1) a collection of name/value pairs. In various languages, this is realized as an object, record, struct, dictionary, hash table, keyed list, or associative array; and (2) an ordered list of values. In most languages, this is realized as an array, vector, list, or sequence.)

Assuming the request does require template intermediation, a matching template is retrieved and sent via network 202 to the individual device. Note that, as shown in FIG. 2, individual devices may be highly individualized templates, or a template may be matched to various devices of a particular “type” or platform or version. For example, as shown, device 203A and 203C may both received “Template A”, while device 203B receives a more suitable “Template B”.

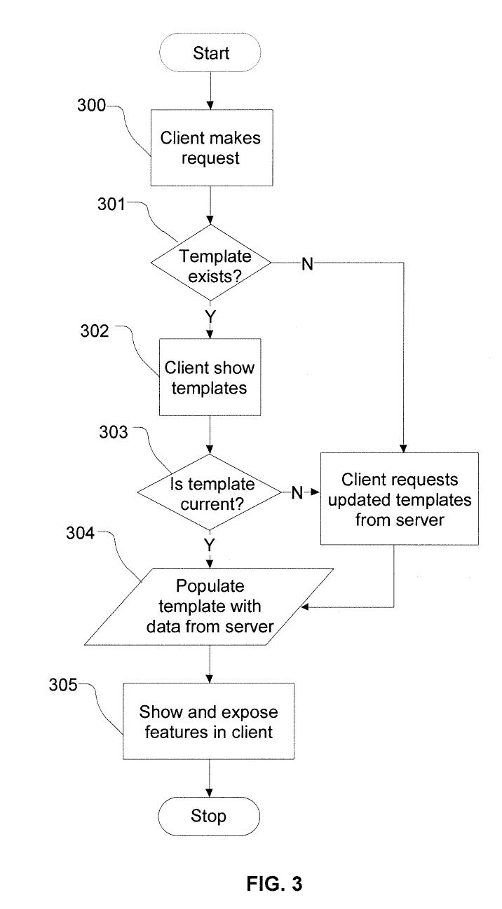

FIG. 3 is a flowchart diagram of the process used by client devices to download templates and render content.

Where the response to the request is mediated via a template, the application sends information about the device and its capabilities to the server, which then selects the most appropriate template according to the circumstances. The information about the device and its capabilities can be sent with every request or, in an alternative embodiment of the invention, less often, for example once per session. Subsequently, the content may be downloaded to populate the template 304. (Alternatively, some or all of the content may be downloaded within or separately from the template or retrieved from the device itself.) The content is rendered on the device 305 in accordance with how the template is interpreted for that particular device. This results in the final rendered layout instance as exemplified in FIG. 1.

The determination of UI objects (HTML 5, native elements) can be established in several ways. Some devices, such as phones and tablets, have fixed specifications that can be looked up via a device's user agent string. The device detection/lookup scheme allows the system to determine the specifications of the device at the current moment. Another approach is to include device capabilities when requesting a template.

The core logic, which determines how templates are distributed when requests are made 300, is exemplified in FIG. 3. Once the client requests to initiate logic processing by making a request 300, the client device determines whether a template exists for the request type 301. If no such template exists, it downloads the latest from the central server 201. If a template does exist, the template is loaded 302. The client device 303 then queries the server 201 in order to determine if the template is up to date. If required, the latest version of the template is downloaded. Finally, data may be sent (or retrieved) to populate the template 304 on the client UI and the user sees and can interact with the data 305 according to behaviors and rules specified in the template. The process is then repeated at intervals or as data/content changes or when new user/device requests are made.

The intent of the application is to cover all such combinations and permutations not listed here but that would be obvious to one skilled in the art. The above examples are not intended to be limiting, but are illustrative and exemplary.

The examples noted here are for illustrative purposes only and may be extended to other implementation embodiments. While several embodiments are described, there is no intent to limit the disclosure to the embodiment(s) disclosed herein. On the contrary, the intent is to cover all alternatives, modifications, and equivalents obvious to those familiar with the art.

What is claimed is:

1. A method of publishing content on a mobile device, comprising:
in response to a request for content from the mobile device, retrieving from an application on the device information as to the device's capabilities and native feature set;
matching the device information to an applicable template via a platform lookup matrix; and
sending the matched template to the device for rendering with content, the template including a combination of components reliant on the device's native feature set and generic components from a standard.

2. The method of claim 1, further comprising populating the template with content prior to sending to the device.

3. The method of claim 1, further comprising sending content separately from the template to be rendered using the template on the device.

4. The method of claim 1, wherein the template contains instructions for locating and rendering content already on the device.

5. The method of claim 1, wherein the template contains instructions for retrieving and rendering on the device content from an onboard GPS.

6. The method of claim 1, wherein the template contains instructions for retrieving and rendering on the device content from an onboard camera.

7. The method of claim 1, wherein the template contains instructions for retrieving and rendering on the device content updated at periodic intervals from a web server.

8. The method of claim 1, wherein the template contains instructions for rendering a combination of fixed and interactive content.

9. The method of claim 1, wherein the device information includes a fixed specification that is looked up in the platform lookup matrix using a user agent string specific to the device.

10. The method of claim 1, wherein the device information includes a list of device capabilities that is matched to an applicable template in the platform lookup matrix.

11. The method of claim 1, wherein the standard is a markup language.

12. The method of claim 1, wherein the standard is HTML5.

13. The method of claim 1, wherein the template is a cross-platform template matchable to multiple devices having similar capabilities.

14. The method of claim 1, wherein the template includes instructions to retrieve or update web content at periodic intervals.

15. The method of claim 1, wherein the template includes native objects embedded in a generic framework.

16. The method of claim 1, further comprising supplying a generic component in the template if there is no native feature to support that component.

17. The method of claim 1, further comprising supplying a template of reduced graphics or interactivity if it is determined from the application that the device has limited memory or processing capacity.

18. A programmed mobile device for receiving and rendering published content, comprising instructions for:
sending a request for content to a central server, together with information retrieved from an application on the device as to the device's capabilities and native feature set;
receiving a template that has been matched to the device information via a platform lookup matrix on the central server; and
receiving and rendering content via the template, wherein the template includes a combination of components reliant on the device's native feature set and generic components from a standard.
